(19) United States
(12) Patent Application Publication
(10) Pub. No.: US 2024/0378385 A1
(43) Pub. Date: Nov. 14, 2024

(54) IMAGE PROCESSING TECHNIQUES FOR GENERATING PREDICTIONS

(71) Applicant: Optum Services (Ireland) Limited, Dublin (IE)

(72) Inventors: Neill Michael BYRNE, Dublin (IE); Kieran O'DONOGHUE, Dublin (IE); Michael J. McCARTHY, Dublin (IE); Mostafa BAYOMI, Dublin (IE)

(21) Appl. No.: 18/313,426

(22) Filed: May 8, 2023

(51) Int. Cl. G06F 40/284; G06V 30/414

(52) U.S. Cl. CPC G06F 40/284; G06V 30/414

(57) ABSTRACT

Systems and methods are disclosed for predicting diagnoses in medical records. A method includes receiving one or more documents, wherein the one or more documents include medical records. An optical character recognition (OCR) engine is used to extract text from the one or more documents. A natural language processing (NLP) model is used to determine one or more predictions and attention scores for one or more tokens in the one or more documents, wherein each of the one or more tokens represents a word in the extracted text. The one or more tokens are aggregated based on the one or more attention scores to construct sentences. The constructed sentences are presented to a user via a graphical user interface of a device.

### TECHNICAL FIELD

This present disclosure relates generally to the field of medical data analysis. In particular, the invention relates to applying optical character recognition (OCR) and natural language processing (NLP) for scoring and predicting diagnoses from medical records.

### BACKGROUND

Document processing involves extracting relevant data from documents, and utilizing the extracted data as inputs to attain business objectives. In one instance, relevant data extracted from documents related to healthcare include, but is not limited to, evidence of a medical diagnosis, a date of the medical diagnosis, a record of family history, a review of medications, or an outcome of a medical procedure. Conventional document processing can be fully manual, where document processors (e.g., coders) read the document and transcribe or collect references to the important information within the document. Such manual document processing is labor intensive, costly, slow, and can vary in quality. For example, the documents are not standardized (e.g., available in different formats) and are complex (e.g., technical and range from hundreds to thousands of pages), hence the manual process of finding relevant data is time-consuming and patients may miss the time window to submit their claims.

In recent times, semi-automated systems comprising OCR, semantic segmentation, named entity recognition, and document classification have been developed to improve the field of document processing. However, the semi-automated systems have several technical drawbacks, such as (i) they are rule-based and have poor predictive abilities, (ii) they require some manual processing, making document processing slow and inefficient, (iii) the quality of semi-automated document processors varies, (iv) technical difficulties in scaling to various document processing tasks, (v) technical difficulties in incorporating NLP models, and/or (vi) a requirement of vast domain-specific knowledge to interpret documents.

### SUMMARY OF THE DISCLOSURE

The present disclosure solves this problem and/or other problems described above or elsewhere in the present disclosure and improves the state of conventional healthcare applications.

Presently, digital images and written reports often serve as a basis of diagnostic assessment. However, the interpretation of digital images is often complex, requiring significant medical knowledge as well as an ability to detect subtle or complicated patterns of information in the correct context. Patients can have had their diagnostic image data interpreted incorrectly, leading to the wrong diagnosis. Such complexity of document processing tasks, the requirement of vast healthcare domain knowledge by the document processors (e.g., coders), and the unstandardized format of healthcare documentation are problems with a strong-felt need for a technical solution. Accordingly, methods and systems that can detect and predict diagnoses from medical records in an accurate manner are disclosed.

In some embodiments, a computer-implemented method for predicting diagnoses in medical records is disclosed. The computer-implemented method includes: receiving, by one or more processors, one or more documents, wherein the one or more documents include medical records; extracting, by the one or more processors and utilizing an optical character recognition (OCR) engine, text from the one or more documents; determining, by the one or more processors and utilizing a natural language processing (NLP) model, one or more predictions and attention scores for one or more tokens in the one or more documents, wherein each of the one or more tokens represents a word in the extracted text; aggregating, by the one or more processors, the one or more tokens based on the one or more attention scores to construct sentences; and causing to be displayed, by the one or more processors, a presentation of the constructed sentences in a graphical user interface of a device.

In some embodiments, a system for predicting diagnoses in medical records is disclosed. The system includes: one or more processors; and at least one non-transitory computer readable medium storing instructions which, when executed by the one or more processors, cause the one or more processors to perform operations including: receiving one or more documents, wherein the one or more documents include medical records; extracting, utilizing an optical character recognition (OCR) engine, text from the one or more documents; determining, utilizing a natural language processing (NLP) model, one or more predictions and attention scores for one or more tokens in the one or more documents, wherein each of the one or more tokens represents a word in the extracted text; aggregating the one or more tokens based on the one or more attention scores to construct sentences; and causing to be displayed a presentation of the constructed sentences in a graphical user interface of a device.

In some embodiments, a non-transitory computer readable medium for predicting diagnoses in medical records is disclosed. The non-transitory computer readable medium stores instructions which, when executed by one or more processors, cause the one or more processors to perform operations including: receiving one or more documents, wherein the one or more documents include medical records; extracting, utilizing an optical character recognition (OCR) engine, text from the one or more documents; determining, utilizing a natural language processing (NLP) model, one or more predictions and attention scores for one or more tokens in the one or more documents, wherein each of the one or more tokens represents a word in the extracted text; aggregating the one or more tokens based on the one or more attention scores to construct sentences; and causing to be displayed a presentation of the constructed sentences in a graphical user interface of a device.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system that is capable of calculating attention scores and predicting diagnoses in medical records, according to aspects of the disclosure.

FIG. 2 is a diagram of the components of a prediction platform 109, according to aspects of the disclosure.

FIG. 3 is a flowchart of a process for calculating attention scores and predicting diagnoses in medical records, according to aspects of the disclosure.

FIG. 4 is a diagram that illustrates a document enrichment pipeline, according to aspects of the disclosure.

FIG. 5 is a diagram that illustrates a prediction platform generating and aggregating attention scores, according to aspects of the disclosure.

FIG. 6 is a diagram that illustrates a micro-service based architecture for predicting diagnoses in medical records, according to aspects of the disclosure.

FIG. 7A is a user interface diagram for uploading documents, according to aspects of the disclosure.

FIGS. 7B-7D are diagrams that illustrate presentations of enriched documents in a user interface of a device, according to aspects of the disclosure.

FIG. 8 shows an example machine learning training flow chart.

FIG. 9 illustrates an implementation of a computer system that executes techniques presented herein.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of systems and methods disclosed herein for detecting and predicting diagnoses from medical records.

Medical coding (e.g., current procedural terminology (CPT) codes) is the transformation of healthcare diagnoses, procedures, medical services, and equipment into universal medical alphanumeric codes. The CPT codes provide a uniform language that details medical, surgical, and diagnostic services utilized by healthcare providers to communicate to third-party payers for the services that are rendered. The diagnoses and procedure codes are taken from medical records (e.g., transcription of physician's notes, laboratory and radiologic results, etc.), and medical coding professionals help ensure the codes are applied correctly during the medical billing process, which includes abstracting the information from the medical records, assigning the appropriate codes, and creating a claim to be paid by insurance carriers. Computer-aided coding systems are examples of semi-automated document processing systems used in healthcare. This document processing task includes text classification, named entity recognition, and document prioritization.

Medical information associated with patients is routinely collected when the patients visit healthcare providers (e.g., physicians, surgeons, etc.). Typically, such medical information is recorded manually on paper forms by healthcare providers, medical staff, or nurses. The medical information may also be dictated by the healthcare providers and later transcribed into another form by medical transcriptionists. In one instance, a medical technician with knowledge of medical information and medical codes processes the information to assign the proper CPT codes, this manual process is error-prone. In another instance, medical codes are manually handled by different people (e.g., healthcare providers, nurses, medical staff, medical billing specialists, etc.) with varying levels of expertise pertaining to the coding of medical information. This handling introduces errors in the coding of medical information at many different levels. Accurate and proper coding of medical information is important to determine financial reimbursement for the services. It is also important to ensure compliance with state and federal regulations as well as help protect healthcare providers from the financial and legal ramifications of government, insurance companies, and other types of audits. As discussed, the semi-automated systems introduced to resolve the drawbacks of the manual process have their own technical challenges (e.g., poor predictive abilities, the varying level of quality, technical difficulties in terms of scaling and incorporating NLP models, etc.).

In one instance, healthcare providers need to contact insurers for authorization in advance of certain medical procedures (e.g., MRIs and CT scans). The insurers must verify the authorization request by reviewing the medical documentation provided with the authorization request and approve the medical procedures for the patients. Such approval for performing medical procedures is a requirement for healthcare providers to be reimbursed for the services rendered. In another instance, Healthcare Effectiveness Data and Information Set (HEDIS) is a comprehensive set of standardized performance measures designed to provide purchasers and consumers with the information they need for reliable comparison of health plan performance. HEDIS measures relate to many significant public health issues (e.g., cancer, heart disease, smoking, asthma, diabetes, etc.). In order to demonstrate the quality of their health plans, insurers must gather evidence from the medical charts of their members to prove HEDIS measures are met. This is a complex document processing task that includes text classification, named entity recognition, and document prioritization. The complexity of document processing tasks combined with the vast healthcare domain knowledge required by document processors (e.g., coders) and the unstandardized format of healthcare documentation makes this an area ripe for improvement.

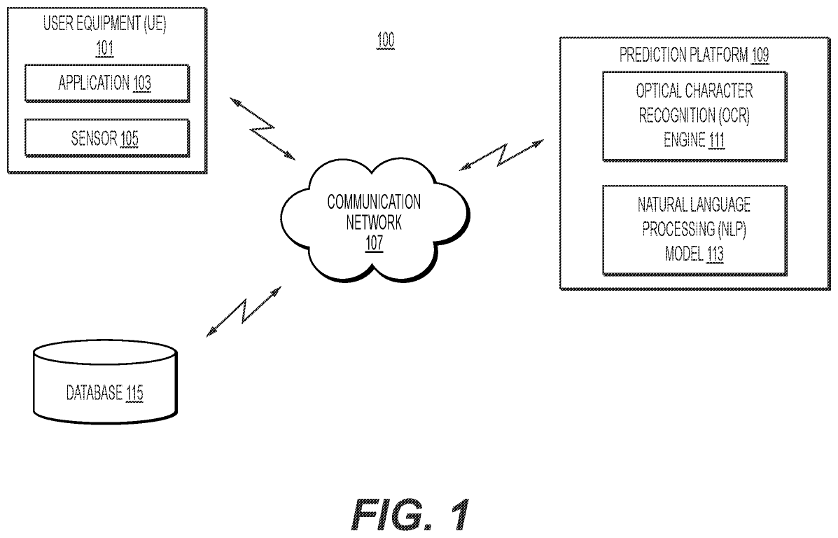

To address these technical challenges, FIG. 1 implements modern document and data processing capabilities into methods and systems for processing medical documents to predict diagnoses, generate attention scores, and identify relevant data in a highly reliable and accurate fashion without substantially sacrificing processing time. In one instance, this approach reduces the occurrence of human errors and generates highly accurate predictions by utilizing a combination of OCR, NLP, and/or other machine-learning based techniques in an unconventional manner. For example, the correct application of medical codes to various medical procedures ensures compliance with state and federal regulations and prevents healthcare providers from the financial and legal ramifications of government, insurance companies, and other types of audits. In another instance, this approach minimizes the technical difficulties experienced in scaling to various document processing tasks. For example, the method utilizes OCR to perform data standardization, thereby reducing challenges experienced during the processing of non-standardized and complex medical documents. In a further instance, this approach is highly efficient and minimizes the chances of patients missing their time window to submit their claims. FIG. 1, an example architecture of one or more example embodiments of the present invention, includes a system 100 that comprises user equipment (UE) 101a-101n (collectively referred to as UE 101) that includes applications 103a-103n (collectively referred to as an application 103) and sensors 105a-105n (collectively referred to as a sensor 105), a communication network 107, a prediction platform 109, an OCR engine 111, an NLP model 113, and a database 115.

System 100 incorporates the OCR engine 111, the NLP model 113, and a continuous learning component for document enrichment, document processing user interface, and incremental learning. In one embodiment, document enrichment includes: (i) extracting texts from documents (e.g., medical records) and generating bounding boxes utilizing the OCR engine 111, (ii) making predictions with the extracted texts and generating attention scores utilizing the NLP model 113, and (iii) incorporating the extracted text, bounding boxes, and attention scores into the documents (e.g., enriched document). In one embodiment, the document processing user interface integrates the enriched document to a web front end and provides various user interface features (e.g., highlighting predictions within the documents, highlighting terms with attention scores within the documents, etc.). In one embodiment, incremental learning includes collecting labeled data and utilizing the labeled data to train, retrain, and/or update the existing NLP models, machine learning models, etc. In one embodiment, system 100 is designed with a micro-service based architecture, that is horizontally scalable. System 100 extracts the attention scores of the model, aggregates them up to their overall sentence, and then visually represents that attention score in the document using a bounding box with color intensity related to the magnitude of the attention score.

In one embodiment, the UE 101 includes but is not restricted to, any type of mobile terminal, wireless terminal, fixed terminal, or portable terminal. Examples of the UE 101 include image input devices (e.g., scanners, cameras, etc.), hand-held computers, desktop computers, laptop computers, wireless communication devices, cell phones, smartphones, mobile communications devices, a Personal Communication System (PCS) device, tablets, server computers, gateway computers, or any electronic device capable of providing or rendering imaging data. In one example embodiment, the UE 101 scans paper medical documents and creates one or more digital images in pre-determined formats (e.g., Portable Document Format (PDF), Bit Map (BMP), Graphics Interchange Format (GIF), Joint Pictures Expert Group (“JPEG”), or any other formats). In one example embodiment, the UE 101 generates a presentation of various user interfaces for the users (e.g., patients, physicians, nurses, medical staff, etc.) to upload medical records for processing. In one embodiment, the UE 101 is configured with different features to enable generating, sharing, and viewing of visual content. Any known and future implementations of the UE 101 are also applicable.

In one embodiment, the application 103 includes various applications such as, but not restricted to, camera/imaging applications, content provisioning applications, software applications, networking applications, multimedia applications, media player applications, storage services, contextual information determination services, notification services, and the like. In one embodiment, one of the application 103 at the UE 101 acts as a client for the prediction platform 109 and performs one or more functions associated with the functions of the prediction platform 109 by interacting with the prediction platform 109 over the communication network 107.

By way of example, each sensor 105 includes any type of sensor. In one embodiment, the sensors 105 include, for example, a network detection sensor for detecting wireless signals or receivers for different short-range communications (e.g., Bluetooth, Wi-Fi, Li-Fi, near field communication (NFC), etc. from the communication network 107), a camera/imaging sensor for gathering image data (e.g., images of medical records), an audio recorder for gathering audio data (e.g., recordings of medical treatments, medical diagnosis, etc.), and the like.

In one embodiment, various elements of the system 100 communicate with each other through the communication network 107. The communication network 107 supports a variety of different communication protocols and communication techniques. In one embodiment, the communication network 107 allows the UE 101 to communicate with the prediction platform 109, the OCR engine 111, and the NLP model 113. The communication network 107 of the system 100 includes one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the prediction platform 109 is a platform with multiple interconnected components. The prediction platform 109 includes one or more servers, intelligent networking devices, computing devices, components, and corresponding software for calculating attention scores and predicting diagnoses in medical records. In one example embodiment, the prediction platform 109 integrates the OCR engine 111, the NLP model 113, a web front end (e.g., user interface of the UE 101), and a continuous learning component (e.g., machine learning) to create a document processing system that generates attention scores and predicts diagnoses in medical records. In one example embodiment, the prediction platform 109 extracts texts from one or more documents (e.g., medical records) and generates bounding boxes. The extracted texts are utilized by the prediction platform 109 to calculate attention scores and predict diagnoses. The prediction platform 109 incorporates the extracted texts, bounding boxes, attention scores, and predicted diagnoses into one or more documents (e.g., enriched documents). Then, the prediction platform 109 integrates the enriched document to a web front end, wherein the predicted diagnoses and attention scores for relevant texts are highlighted by the bounding boxes within one or more documents. An incremental learning component then collects the labeled data to train, retrain, and/or update the existing NLP models, machine learning models, etc. It is noted that the prediction platform 109 may be a separate entity of the system 100.

In one embodiment, the prediction platform 109 aggregates the attention scores to a phrase level. The prediction platform 109 summarizes and highlights sections of documents that are relevant for the document processors to review. For example, the attention scores are visually represented in the documents using bounding boxes with color intensity related to the magnitude of the attention scores. In one embodiment, the prediction platform 109 utilizes the aggregated attention scores to rank relevant sections of the documents, and the ranking is represented in the user interface as a scrollable table that document processors can click to review. In one embodiment, the prediction platform 109 via various machine learning methods predicts the probability of medical codes (e.g., CPT codes, ICD codes, etc.) for the extracted texts. Further details of the prediction platform 109 are provided below.

In one embodiment, the OCR engine 111 processes source images (e.g., images of medical records) utilizing computer algorithms to convert them into editable texts (e.g., OCR'ed text). The OCR engine 111 recognizes typed and handwritten text from the source images. In one embodiment, the OCR engine 111 generates and outputs positional information for image segments containing the editable text in the source images. For example, for each segment of text (e.g., paragraph, column), the OCR engine 111 provides a set of values describing a bounding box that uniquely specifies the region of the source image containing the text segment. These bounding boxes are utilized during the document enrichment process to overlay model predictions and deep learning model attention scores over the words on the document. In some embodiments, the OCR engine 111 is implemented using suitable OCR methodologies, e.g., ABBYY FineReader OCR, ADOBE Acrobat Capture, and MICROSOFT Office Document Imaging. Further details of the OCR engine 111 are provided below.

The editable texts (e.g., OCR'ed text) are transmitted to the NLP model 113 to make predictions. In one embodiment, the NLP model 113 utilizes one or more language modeling techniques (e.g., statistical models, neural-network models, rule-based models, transformers models, sentiment models, topic models, syntactic models, embedding models, dialog or discourse models, emotion or affect models, or speaker personality models, etc.) to perform text classification, named entity recognition, or entity linking. The NLP model 113 builds semantic relationships between the letters, words, and sentences of the editable texts. In one example embodiment, if the task was to identify all the blood pressure readings in a medical chart, the named entity recognition identifies blood pressure readings in the editable texts. In one example embodiment, if the task was to identify pages of medical charts that contain a medication review, the text classification classifies the editable texts as having a medication review or not. In one embodiment, the NLP model 113 with attention mechanisms (e.g., convolutional neural network architecture CAML) extracts token-based attention scores and provides the attention scores in the response. The magnitude of the attention score for each token relates to the importance of the token during the prediction and decision-making process by the NLP model 113. These attention scores provide a means of model interpretability. In one embodiment, the NLP model 113 predicts diagnosis or procedure medical codes (CPT codes, ICD codes, etc.) based on the processing of OCR'ed text. Further details of the NLP model 113 are provided below.

In one embodiment, the database 115 is any type of database, such as relational, hierarchical, object-oriented, and/or the like, wherein data are organized in any suitable manner, including data tables or lookup tables. In one embodiment, the database 115 accesses or stores content associated with the patients, the UE 101, and the prediction platform 109, and manages multiple types of information that provide means for aiding in the content provisioning and sharing process. In one example embodiment, the database 115 stores various information related to the patients (e.g., medical records, claims data, invoice data, image data, etc.). It is understood that any other suitable data may be included in the database 115. In another embodiment, the database 115 includes a machine-learning based training database with a pre-defined mapping defining a relationship between various input parameters and output parameters based on various statistical methods. In one embodiment, the training database includes a dataset that includes data collections that are not subject-specific, e.g., data collections based on population-wide observations, local, regional or super-regional observations, and the like. In an embodiment, the training database is routinely updated and/or supplemented based on machine learning methods.

By way of example, the UE 101, the prediction platform 109, the OCR engine 111, and the NLP model 113 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

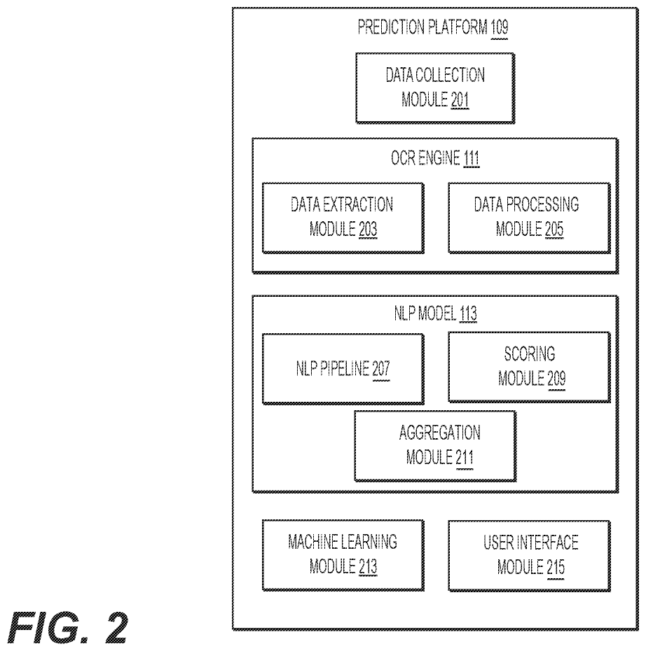

FIG. 2 is a diagram of the components of the prediction platform 109, according to aspects of the disclosure. As used herein, terms such as “component” or “module” generally encompass hardware and/or software, e.g., that a processor or the like used to implement associated functionality. By way of example, the prediction platform 109 includes one or more components for predicting diagnoses in medical records. It is contemplated that the functions of these components are combined in one or more components or performed by other components of equivalent functionality. In one embodiment, the prediction platform 109 comprises a data collection module 201, a data extraction module 203, a data processing module 205, an NLP pipeline 207, a scoring module 209, an aggregation module 211, a machine learning module 213, a user interface module 215, or any combination thereof.

In one embodiment, the data collection module 201 collects relevant data (e.g., images of medical records) associated with the patient through various data collection techniques. In one example embodiment, the data collection module 201 uses a web-crawling component to access various databases, e.g., the database 115, or other information sources to collect relevant data associated with the patients. In one embodiment, the data collection module 201 includes various software applications, e.g., data mining applications in Extended Meta Language (XML), that automatically search for and return relevant data regarding the patients. In another embodiment, the data collection module 201 collects images of medical records uploaded by the users (e.g., patients, physicians, nurses, medical staff, etc.) via the user interface of the UE 101.

In one embodiment, the data extraction module 203 receives the data from the data collection module 201. The data extraction module 203 then extracts textual data from the images of medical records. The extracted textual data is in a rich text, HTML text, or any other text which retains the format and location of the data as it appeared in the images of medical records. In one example embodiment, the data extraction module 203 executes a full extraction wherein data is fully pulled from the images of medical records. In another example embodiment, the data extraction module 203 performs an incremental extraction wherein data that has changed since a particular occurrence in the past is extracted at a given time.

In one embodiment, the data extraction module 203 transmits the extracted data to the data processing module 205 to perform data standardization, error screening, and/or duplicate data removal. In one embodiment, data standardization includes standardizing and unifying data (e.g., converting data into a common format that is easily processed by other modules). In one embodiment, error screening includes removing or correcting erroneous data (e.g., eliminating skew and other characteristics detrimental to image processing operations).

In one embodiment, the NLP pipeline 207 includes sentence segmentation, word tokenization, stemming, lemmatization, stop word analysis, dependency parsing, and/or part-of-speech tagging. In one embodiment, sentence segmentation divides large texts into linguistically meaningful sentence units. In one embodiment, word tokenization splits the sentences into individual words and word fragments to understand the context of the words. The result generally consists of a word index and tokenized text in which words are represented as numerical tokens for use in various deep-learning methods. In one embodiment, stemming normalizes words into their base or root form (e.g., convert words to their base forms by removing affixes). In one embodiment, lemmatization groups together different inflected forms of the same word so that they are analyzed as a single item using vocabulary from a dictionary. In one embodiment, stop word analysis flags frequently occurring words as ‘stop words,’ and these ‘stop words’ are filtered out to focus on important words. In one embodiment, dependency parsing analyzes the grammatical structure in a sentence and finds out related words as well as the type of relationship between them. In one embodiment, part-of-speech tagging contains verbs, adverbs, nouns, and adjectives that help indicate the meaning of words in a grammatically correct way in a sentence.

In one embodiment, the scoring module 209 utilizes various scoring algorithms to generate attention scores for tokens that represent the words in the extracted text. The scoring module 209 quantifies the relevancy of words in the extracted text, and determines words that are most highly representative as relevant for the present query. In one example embodiment, NLP models with attention mechanisms (e.g., convolutional neural network architecture CAML) generate token-based attention scores and provide the token-based attention scores as a response to the request. The attention scores provide a means of model interpretability. The magnitude of the attention score for each token relates to the ‘importance’ of the token as the model makes its decision. For example, high attention scores indicate relevant words, whilst low attention scores indicate less relevant words.

In one embodiment, the aggregation module 211 implements various aggregation techniques to collect attention scores to a phrase level attention. Such aggregation of attention scores interpret the importance of whole phrases in the text and drastically reduces the number of irrelevant sections a document processor might examine based exclusively on token-level attention scores. In one embodiment, the aggregation module 211 determines a minimum score threshold based, at least in part, on past learnings, observations, experiments, or expert opinions. The aggregation module 211 filters attention scores below the minimum score threshold. This reduces data transfer between micro-services and removes attention scores that have little relevance. The minimum score threshold varies on a case-by-case basis. In one embodiment, the aggregation module 211 aggregates the attention scores in real-time, near real-time, or per schedule.

In one embodiment, the machine learning module 213 performs model training using training data (e.g., training data 812 illustrated in the training flow chart 800) that contains input and correct output, to allow the model (e.g., the NLP model 113) to learn over time. The training is performed based on the deviation of a processed result from a documented result when the inputs are fed into the machine learning model, e.g., an algorithm measures its accuracy through the loss function, adjusting until the error has been sufficiently minimized. In one embodiment, the machine learning module 213 randomizes the ordering of the training data, visualizes the training data to identify relevant relationships between different variables, identifies any data imbalances, and splits the training data into two parts where one part is for training a model and the other part is for validating the trained model, de-duplicating, normalizing, correcting errors in the training data, and so on. The machine learning module 213 implements various machine learning techniques, e.g., k-nearest neighbors, cox proportional hazards model, decision tree learning, association rule learning, neural network (e.g., recurrent neural networks, graph convolutional neural networks, deep neural networks), inductive programming logic, support vector machines, Bayesian models, etc. In one example embodiment, the machine learning module 213 performs a mapping between medical codes (e.g., ICD codes, CPT codes, etc.) and the OCR'ed texts to assist the prediction platform 109 in making predictions. Further details on incremental learning are provided below.

In one example embodiment, as document processors complete the document processing task, more labeled data is collected by the system 100. The labeled data is then used to retrain or update the existing NLP models 113 to improve model performance and ultimately reduce the amount of manual work. This process of gathering more data and updating the NLP models 113 or machine learning models is called incremental learning. A distinct benefit of incremental learning is that the document processing task can be started without any machine learning model providing predictions to the processor. As the document processor gathers more data, an initial model can be trained and incorporated into the process. Gradually as more data is collected and model performance is improved, the amount of manual work required by the document processor is reduced and passed off to the system.

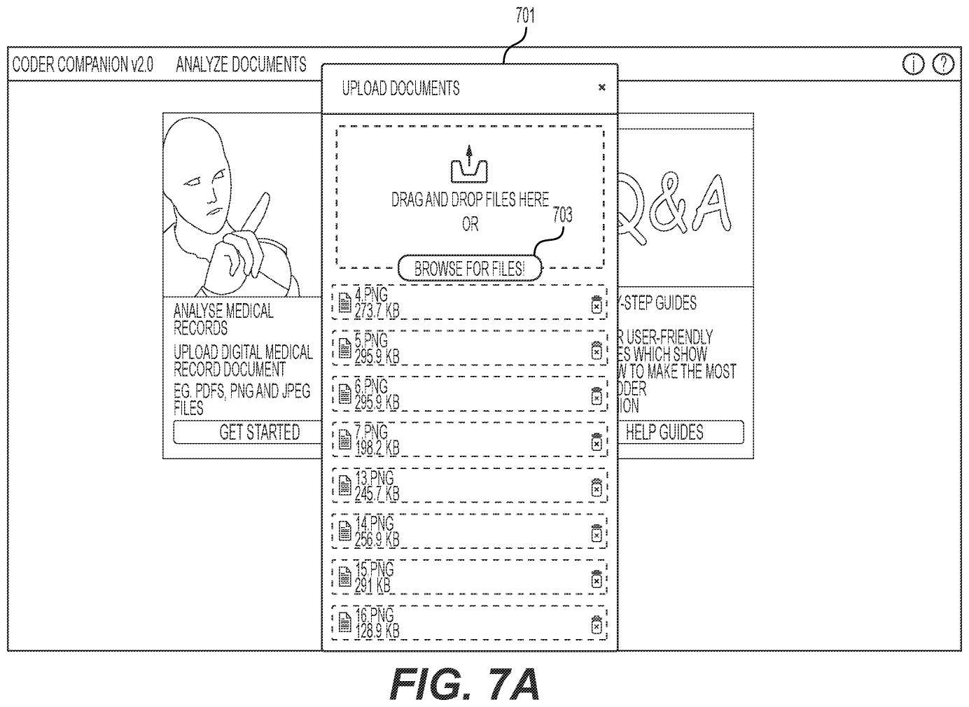

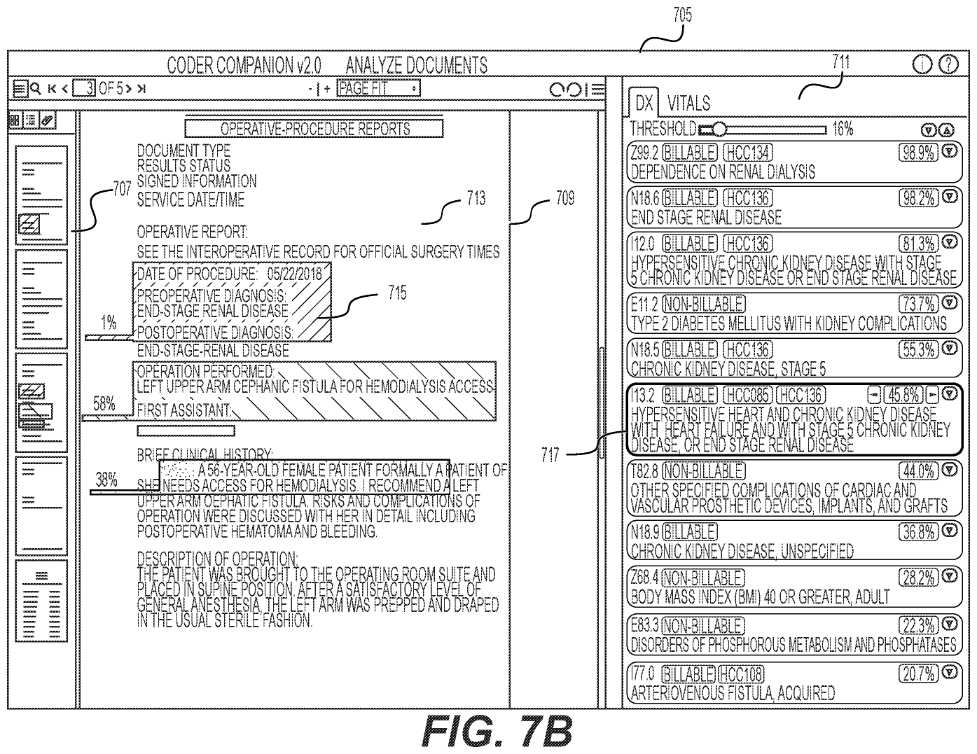

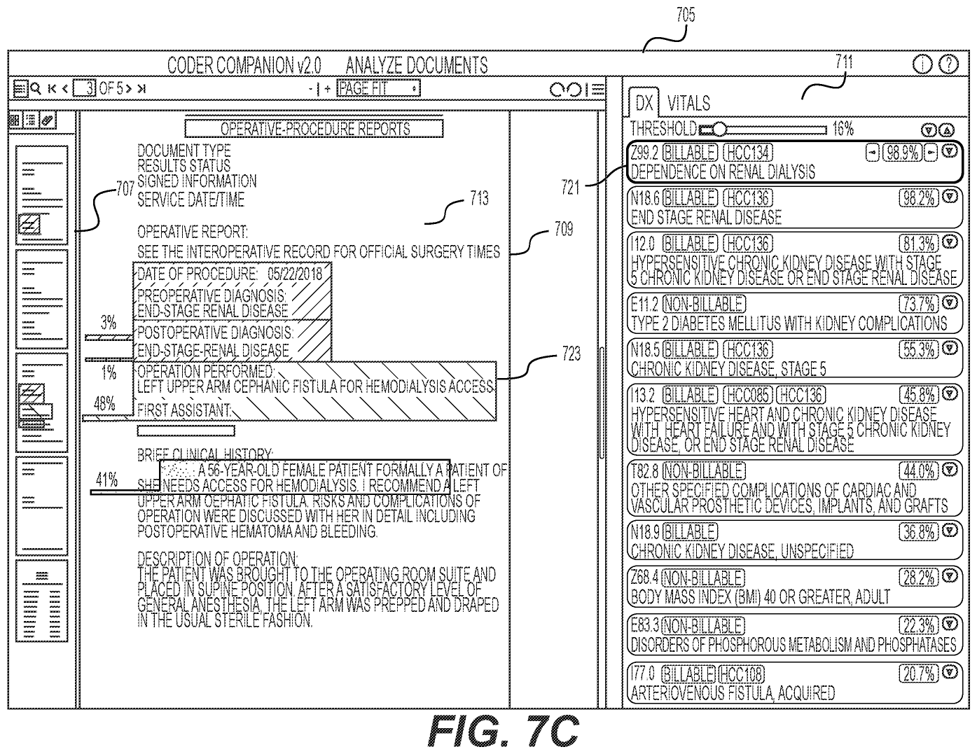

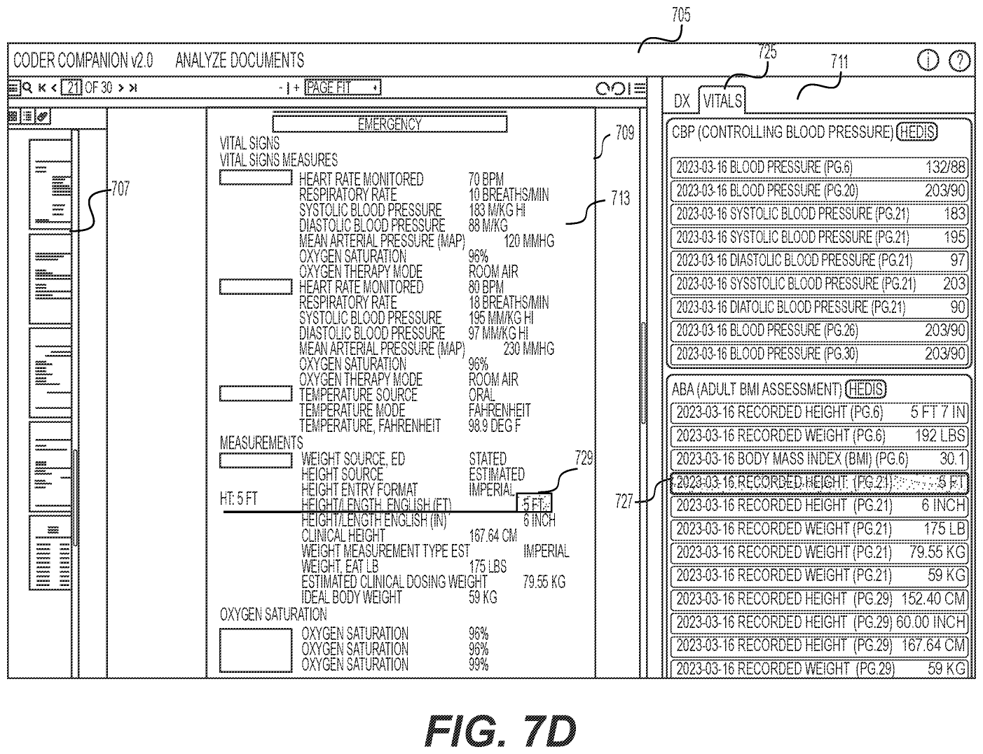

In one embodiment, the user interface module 215 employs various application programming interfaces (APIs) or other function calls corresponding to the application 103 on the UE 101, thus enabling the display of graphics primitives such as icons, bar graphs, menus, buttons, data entry fields, etc. In one example embodiment, the user interface module 215 enables a presentation of a graphical user interface (GUI) in the UE 101 that facilitates the uploading of medical records by the users (as illustrated in FIG. 7A). In another example embodiment, the user interface module 215 enables a presentation of a GUI in the UE 101 that facilitates visualization of enhanced medical records with attention score by utilizing bounding box with a color intensity related to the magnitude of the attention score (as illustrated in FIGS. 7B-7D). In another embodiment, the user interface module 215 causes interfacing of guidance information to include, at least in part, one or more annotations, audio messages, video messages, or a combination thereof pertaining to the information in the enhanced medical records. In one instance, forms in the user interface are pre-filled with predictions, and document processors can accept, reject, or update based on the model predictions. When document processors find the relevant section, they can highlight the relevant words, phrases, or sections. Once the document processor has completed processing the document, the structured data extracted from the document is then saved to the database 115. Downstream users and business processes can then query the database 115 for their own purposes.

The above presented modules and components of the prediction platform 109 are implemented in hardware, firmware, software, or a combination thereof. Though depicted as a separate entity in FIG. 2, it is contemplated that the prediction platform 109 is also implemented for direct operation by the respective UE 101. As such, the prediction platform 109 generates direct signal inputs by way of the operating system of the UE 101. In another embodiment, one or more of the modules 201-215 are implemented for operation by the respective UEs, as the prediction platform 109. The various executions presented herein contemplate any and all arrangements and models.

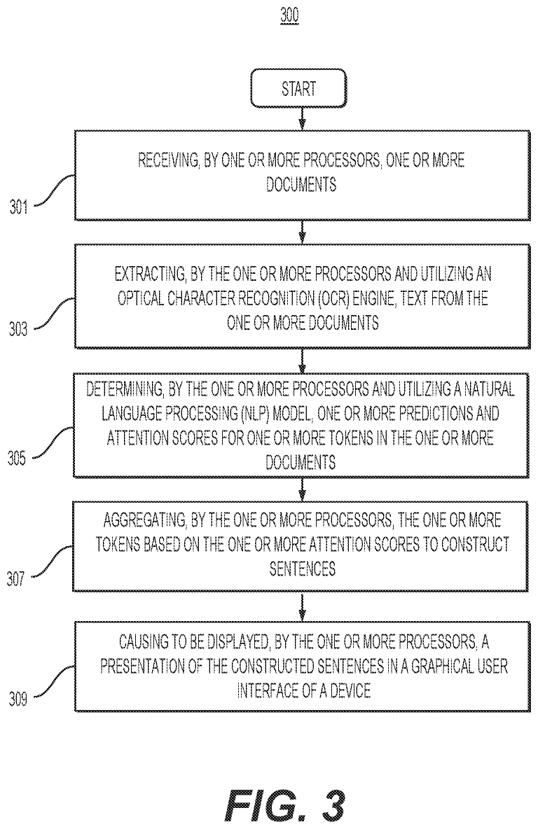

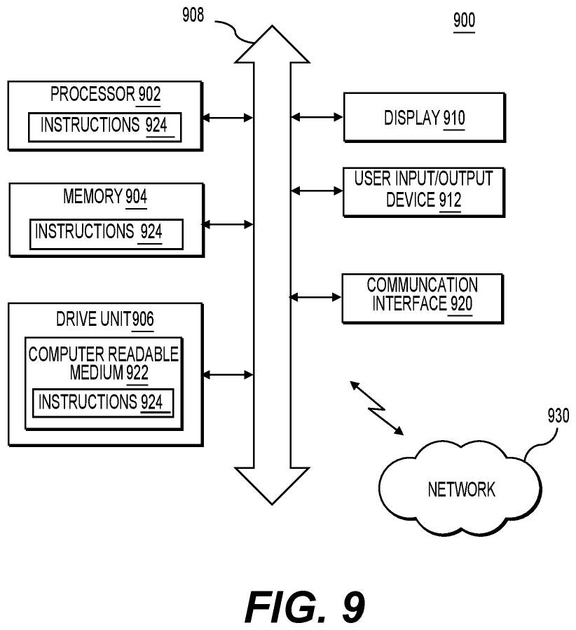

FIG. 3 is a flowchart of a process for calculating attention scores and predicting diagnoses in medical records, according to aspects of the disclosure. In various embodiments, the prediction platform 109 and/or any of the modules 201-215 performs one or more portions of the process 300 and are implemented using, for instance, a chip set including a processor and a memory as shown in FIG. 9. As such, the prediction platform 109 and/or any of modules 201-215 provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 are performed in any order or combination and need not include all of the illustrated steps.

In step 301, the prediction platform 109, via processor 902, receives various types of documents (e.g., medical records). In one embodiment, the documents include scanned images of typed and/or handwritten text, and are in a portable document format. In one example embodiment, the users (e.g., patients, physician, medical staff, etc.) submits the documents via their respective UE 101. In another example embodiment, the prediction platform 109 automatically retrieves the documents (e.g., electronic medical reports) stored in the database 115.

In step 303, the prediction platform 109, via processor 902 and utilizing the OCR engine 111, extracts text from the documents. The extracted text includes words and locations of the words within the documents. In one embodiment, the OCR engine 111 generates bounding boxes for the recognized words and/or phrases in the documents. The bounding boxes indicate the predictions and attention scores, and the intensity of the color or transparency of each of the bounding boxes represents the magnitude of the corresponding attention score.

In step 305, the prediction platform 109, via processors 902 and utilizing the NLP model 113, determines predictions and attention scores for tokens in the documents. The tokens represent a word in the extracted text. In one embodiment, the NLP model 113 includes an attention-based model, a rule-based model, or a statistical model. In one embodiment, the NLP model 113 utilizes logistic regression, neural network, or any advanced models to perform text classification, named entity recognition, or entity linking on the documents. In one embodiment, the prediction platform 109 determines labelled data upon processing of the documents to train or update the NLP model 113.

In step 307, the prediction platform 109, via processor 902, aggregates the tokens based on the attention scores to construct sentences. In one embodiment, the prediction platform 109 determines intervals to cluster the tokens with high attention scores by utilizing an expanding window technique. The tokens with high attention scores are clustered based on a task-based parameter that indicates the quantity of data sought during the processing of the documents. The intervals are positioned around the tokens with high attention scores, and overlapping intervals are merged. In one embodiment, the prediction platform 109 determines an unnormalized aggregated attention score for each interval by summing the high attention scores within the interval. Then, the prediction platform 109 determines a normalized aggregated attention score for each interval based on a softmax function. In one embodiment, the prediction platform 109 determines a threshold value for the attention scores, and filters the tokens based on the threshold value. In one embodiment, the filtered tokens are utilized based on the context of the constructed sentences.

In step 309, the prediction platform 109, via processor 902, causes a presentation of the constructed sentences in a graphical user interface of the UE 101. In one embodiment, the presentation of the constructed sentences includes bounding boxes that are superimposed over the recognized words and/or phrases in the documents. The bounding boxes are colored and/or semi-transparent.

Firstly, State-of-the-art approaches primarily rely on the inherent structure of text where sentences and paragraphs are pre-defined (e.g., delimiters such as “.”, “?” are present in the given text). However, because of the output nature of the OCR engine 111, sentences are not defined in the OCR'ed text. Hence, the prediction platform 109 constructs sentences by aggregating tokens based on their attention scores. Secondly, state-of-the-art aggregation approaches primarily rely on self-attention mechanisms where each token is paying attention to other tokens in the same sentence. Since there are no predefined sentences in the OCR'ed text, the whole document is given as one line of text without any structure. Thus, using a self-attention mechanism is not practical and will not be efficient. System 100 does not rely on the self-attention mechanism and can work with any attention-based model (e.g., CAML which uses label-based attention).

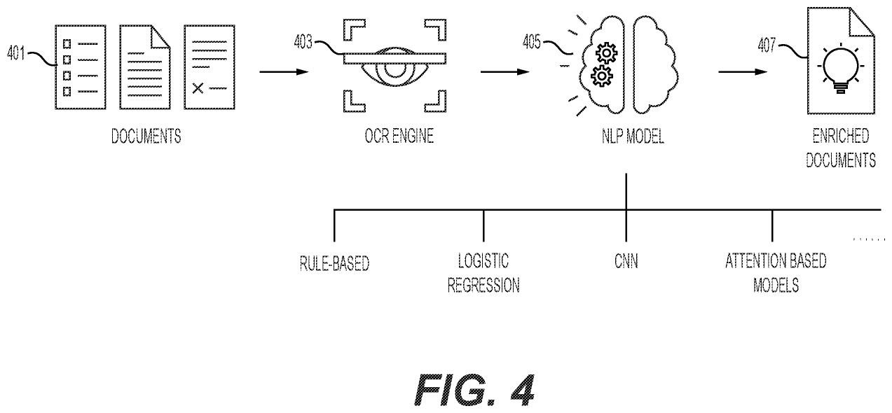

FIG. 4 is a diagram that illustrates a document enrichment pipeline, according to aspects of the disclosure. In step 401, the prediction platform 109 receives a plurality of documents (e.g., scanned images of medical records) in various formats. In step 403, the prediction platform 109 utilizes the OCR engine 111 to process the plurality of documents to extract texts and generate bounding boxes of the recognized text. In step 405, the prediction platform 109 utilizes the NLP model 113 to perform various procedures (e.g., sentence segmentation, word tokenization, stemming, lemmatization, stop word analysis, dependency parsing, part-of-speech tagging, sentiment analysis, etc.) on the extracted texts. The NLP model 113 generates attention scores for tokens that represents one or more words in the extracted text and predicts diagnoses. In one embodiment, the prediction platform 109 aggregates the tokens based on the attention scores to construct sentences. In step 407, the prediction platform 109 utilizes the user interface module 215 to perform a document enrichment process by superimposing bounding boxes, predictions, and attention scores over the relevant section of the plurality of documents in the user interface of the UE 101.

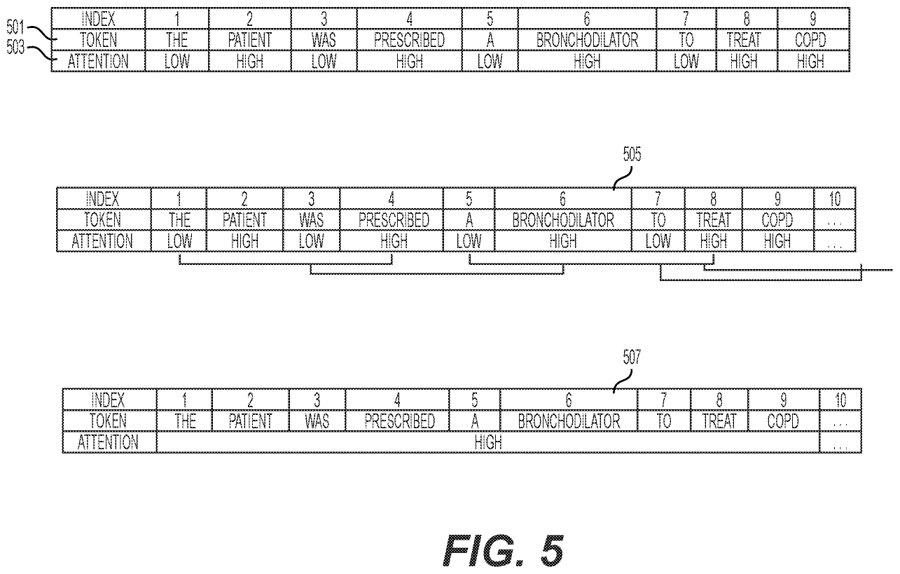

FIG. 5 is a diagram that illustrates a prediction platform generating and aggregating attention scores, according to aspects of the disclosure. In one example embodiment, the prediction platform 109 utilizes the OCR engine 111 to convert scanned images of medical records into editable texts. The prediction platform 109 then utilizes the NLP model 113 to split sentences of the editable texts into individual words that are represented as tokens. The NLP model 113 generates attention scores for each of the tokens, wherein the attention score relates to the importance of the token during a decision-making process (e.g., predict diagnoses) by the NLP model 113.

As document processing tasks find or extract relevant words or phrases in documents, tokens with high attention scores tend to cluster together. The prediction platform 109 implements an aggregation technique that is designed to take advantage of such clustering of high attention scores. The aggregation technique uses an expanding window method to create intervals of important words (e.g., words with high attention scores). In one embodiment, the prediction platform 109 selects top N attention scores. N is a task-based parameter that reflects the quantity of evidence or information sought during the document processing task. For example, if only one piece of evidence is required, then Nis a low number. However, if numerous pieces of evidence or information are required, then Nis a higher number. The prediction platform 109 places a window of size W around the top N words. Similar to N, W is a task-based parameter that reflects the size of sections that the system generates. For example, if the task requires matching large sections, W is chosen to be large. Whereas, if the task requires finding few words, then N can be chosen to be small. In one embodiment, the prediction platform 109 aggregates the attention scores to a phrase level attention. The prediction platform 109 retrieves the attention scores within each interval and sums them to generate an unnormalized aggregated attention score for the interval. The prediction platform 109 utilizes a softmax function for each interval to generate a normalized aggregated attention score. Such aggregation of attention scores makes it possible to interpret the importance of whole phrases in the text and drastically reduce the number of irrelevant sections a document processor might examine based on attention scores alone.

In one embodiment, if the window surrounding two top N words overlaps, the prediction platform 109 merges the windows. For example, if numerous pieces of evidence are required during the document processing task, the prediction platform 109 may start with 40 context windows. Some of these windows overlap, hence rather than show separate windows, the prediction platform 109 merges the overlapping windows and generates attention scores. The prediction platform 109 continues with the window expansion until there are no more merges.

In one example embodiment, the prediction platform 109 classifies a COPD diagnoses from the phrase “The patient was prescribed a bronchodilator to treat COPD,” in a document. As illustrated, each word of the predicted phrase is represented as token 501, and each of the token 501 is assigned an attention score 503. In one instance, a token with a high attention score indicates high relevancy for the query whereas a token with a low attention score indicates low relevancy. In one instance, low attention scores are irrelevant to the document processing task. The prediction platform 109 determines an attention score threshold (e.g., based on learning, observations, experiments, or expert opinions) to filter out attention scores that are below the threshold. This reduces data transfer between micro-services and removes attention scores that have little relevance.

In another instance, tokens with low attention scores are utilized based on the context of the sentence. As illustrated in table 505, the prediction platform 109 links low attention scores with high attention scores to determine the overall context of the phrase. As depicted in table 507, the prediction platform 109 determines a phrase level attention score. The prediction platform 109 determines a high phrase level attention score indicating high relevancy and a high correlation between the attention scores.

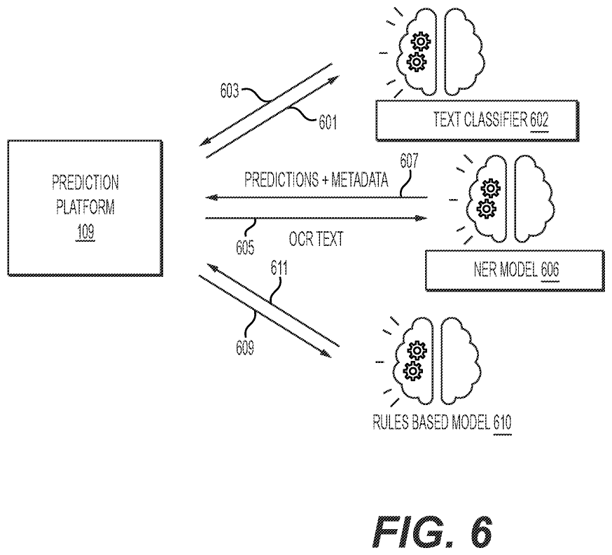

FIG. 6 is a diagram that illustrates a micro-service based architecture for predicting diagnoses in medical records, according to aspects of the disclosure. In one example embodiment, a user uploads scanned images of medical records via a user interface of the UE 101 or the prediction platform 109 automatically retrieves the scanned images of medical records from the database 115. The prediction platform 109 then converts the scanned images to base64 format or other suitable format.

In step 601, the prediction platform 109 transmits the scanned images in base64 format (or other suitable format) to a text classifier 602. In one instance, the text classifier 602 is a microservice, and converts the scanned images into editable and shareable PDFs (or other data files/objects) that are machine-readable. In step 603, the text classifier 602 transmits words and the location of the words within the scanned images to the prediction platform 109. In one instance, the prediction platform 109 has the scanned images, the words, and the location of the words. The prediction platform 109 creates a text layer with bounding boxes over the scanned images and converts it into an in-memory pdf that sits in the user interface (e.g., browser) of the UE 101.

In step 605, the prediction platform 109 transmits the words to a name entity recognition (NER) model 606 over HTTP requests for scoring (e.g., attention score) and predictions (e.g., ICD code predictions). The NER model 606 (a form of NLP) processes the words to generate the attention scores and predictions. In step 607, the NER model 606 transmits the attention scores, predictions, and any relevant metadata to the prediction platform 109 in a JavaScript Object Notation (JSON) response or in any other suitable response.

In step 609, the prediction platform 109 communicates with rule-based model 610 to make decisions based on a certain set of rules. In one example embodiment, the rule-based model includes learning classifier systems, association rule learning, artificial immune systems, or any other method that relies on a set of rules, each covering contextual knowledge. In step 611, the rule-based model 610 transmits relevant data to the prediction platform 109 to assist in the decision making process.

FIG. 7A is a user interface diagram for uploading documents, according to aspects of the disclosure. In one embodiment, the prediction platform 109 via the user interface module 215 generates user interface 701 in the UE 101 of the users (e.g., patients, physicians, medical staffs, etc.) for uploading medical records. In one instance, the prediction platform 109 via the user interface module 215 provides guidance information to the users (e.g., audio/visual tutorials) for uploading medical records. In one embodiment, the prediction platform 109 via the user interface module 215 generates user interface 703 for browsing stored documents, e.g., scanned images of medical records stored in the UE 101 or the database 115.

FIGS. 7B-7D are diagrams that illustrate presentations of enriched documents in a user interface of a device. In FIG. 7B, a user interface 705 is divided into three sections: mini view 707, main view 709, and navigation pane 711. It is understood that the user interface 705 may be divided into additional sections based on the requirements and the configuration of the UE 101. In this example embodiment, the prediction platform 109 visually incorporates model predictions and attention scores into the enriched document 713 presented in the main view 709 to intuitively communicate the predictions and attention scores within the context of the document. In one example embodiment, the prediction platform 109 represents predictions by the NLP model 113 as semi-transparent bounding box 715 over the predicted entity (e.g., words and phrases) in the enriched document 713 by utilizing the bounding boxes returned by the OCR engine 111. In another example embodiment, the prediction platform 109 aggregates the attention scores according to the technique described herein and overlays bounding boxes over the intervals returned. The intensity of the color of the bounding box 715 matches the magnitude of the aggregated attention score. In one instance, a user utilizing interface 705 selects portions of navigation pane 711 to find relevant words or sentences within the enriched document 713. For example, a user clicks on element 717 of the navigation pane 711, whereupon the user is displayed the relevant portion of the enriched document 713 in the main view 709.

In one embodiment, the prediction platform 109 integrates the enriched document to a web front end so that users (e.g., document processors) can interact with the interface to extract key data into structured data. Similarly in FIG. 7C, a user selects element 721 of the navigation pane 711, and is displayed a relevant portion of the enriched document 713 in the main view 709. For example, element 721 includes ICD codes for renal dialysis, the user is navigated to the page of the enriched document 713 on renal dialysis, where evidence and/or relevant portions are highlighted (e.g., bounding box 723 indicating model predictions and attention scores superimposed on the relevant portions). In such a manner, the prediction platform 109 highlights predictions within the documents, presents options for the processor to skip to sections or pages of interest, and highlights terms with attention scores to draw attention to terms and sentences the model thought were important.

In FIG. 7D, a user selects tab 725 of the navigation pane 711 to focus on data related to a patient's vital. The tab 725 generates a list of user interface elements within the navigation pane 711. The user selects element 727 from the list, whereupon the user is displayed a relevant portion 729 of the enriched document 713 in the main view 709. In one instance, the relevant portion 729 is highlighted with color or bounding boxes.

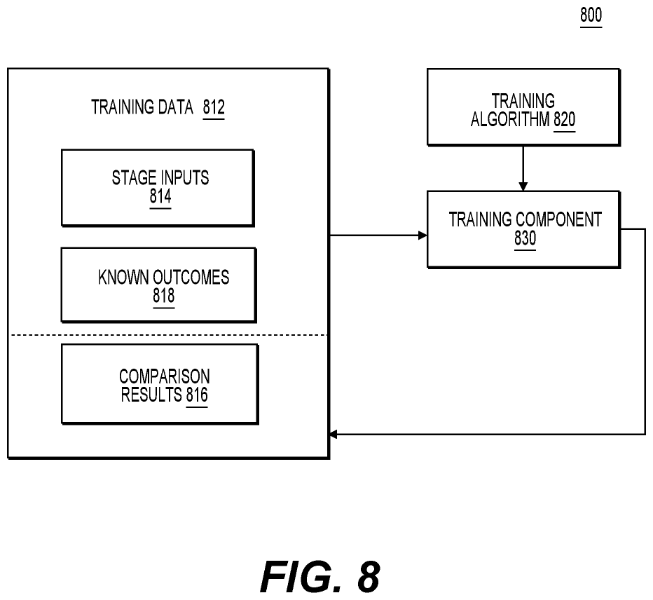

One or more implementations disclosed herein include and/or are implemented using a machine learning model. For example, one or more of the modules of the prediction platform 109, e.g., the machine learning module 213, are implemented using a machine learning model and/or are used to train the machine learning model. A given machine learning model is trained using the training flow chart 800 of FIG. 8. Training data 812 includes one or more of stage inputs 814 and known outcomes 818 related to the machine learning model to be trained. Stage inputs 814 are from any applicable source including text, visual representations, data, values, comparisons, and stage outputs, e.g., one or more outputs from one or more steps from FIG. 3. The known outcomes 818 are included for the machine learning models generated based on supervised or semi-supervised training. An unsupervised machine learning model may not be trained using known outcomes 818. Known outcomes 818 includes known or desired outputs for future inputs similar to or in the same category as stage inputs 814 that do not have corresponding known outputs.

The training data 812 and a training algorithm 820, e.g., one or more of the modules implemented using the machine learning model and/or are used to train the machine learning model, is provided to a training component 830 that applies the training data 812 to the training algorithm 820 to generate the machine learning model. According to an implementation, the training component 830 is provided comparison results 816 that compare a previous output of the corresponding machine learning model to apply the previous result to re-train the machine learning model. The comparison results 816 are used by training component 830 to update the corresponding machine learning model. The training algorithm 820 utilizes machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 3 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 9 illustrates an implementation of a computer system that executes techniques presented herein. The computer system 900 includes a set of instructions that are executed to cause the computer system 900 to perform any one or more of the methods or computer based functions disclosed herein. The computer system 900 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 900 operates in the capacity of a server or as a client user computer in a server-client user network environment, or as a peer computer system in a peer-to-peer (or distributed) network environment. The computer system 900 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 900 is implemented using electronic devices that provide voice, video, or data communication. Further, while the computer system 900 is illustrated as a single system, the term “system” shall also be taken to include any collection of systems or sub-systems that individually or jointly execute a set, or multiple sets, of instructions to perform one or more computer functions.

As illustrated in FIG. 9, the computer system 900 includes a processor 902, e.g., a central processing unit (CPU), a graphics processing unit (GPU), or both. The processor 902 is a component in a variety of systems. For example, the processor 902 is part of a standard personal computer or a workstation. The processor 902 is one or more processors, digital signal processors, application specific integrated circuits, field programmable gate arrays, servers, networks, digital circuits, analog circuits, combinations thereof, or other now known or later developed devices for analyzing and processing data. The processor 902 implements a software program, such as code generated manually (i.e., programmed).

The computer system 900 includes a memory 904 that communicates via bus 908. Memory 904 is a main memory, a static memory, or a dynamic memory. Memory 904 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 904 includes a cache or random-access memory for the processor 902. In alternative implementations, the memory 904 is separate from the processor 902, such as a cache memory of a processor, the system memory, or other memory. Memory 904 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts, or tasks illustrated in the figures or described herein are performed by processor 902 executing the instructions stored in memory 904. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 900 further includes a display 910, such as a liquid crystal display (LCD), an organic light emitting diode (OLED), a flat panel display, a solid-state display, a cathode ray tube (CRT), a projector, a printer or other now known or later developed display device for outputting determined information. The display 910 acts as an interface for the user to see the functioning of the processor 902, or specifically as an interface with the software stored in the memory 904 or in the drive unit 906.

Additionally or alternatively, the computer system 900 includes an input/output device 912 configured to allow a user to interact with any of the components of the computer system 900. The input/output device 912 is a number pad, a keyboard, a cursor control device, such as a mouse, a joystick, touch screen display, remote control, or any other device operative to interact with the computer system 900.

The computer system 900 also includes the drive unit 906 implemented as a disk or optical drive. The drive unit 906 includes a computer-readable medium 922 in which one or more sets of instructions 924, e.g. software, is embedded. Further, the sets of instructions 924 embodies one or more of the methods or logic as described herein. Instructions 924 resides completely or partially within memory 904 and/or within processor 902 during execution by the computer system 900. The memory 904 and the processor 902 also include computer-readable media as discussed above.

In some systems, computer-readable medium 922 includes the set of instructions 924 or receives and executes the set of instructions 924 responsive to a propagated signal so that a device connected to network 930 communicates voice, video, audio, images, or any other data over network 930. Further, the sets of instructions 924 are transmitted or received over the network 930 via the communication port or interface 920, and/or using the bus 908. The communication port or interface 920 is a part of the processor 902 or is a separate component. The communication port or interface 920 is created in software or is a physical connection in hardware. The communication port or interface 920 is configured to connect with the network 930, external media, display 910, or any other components in the computer system 900, or combinations thereof. The connection with network 930 is a physical connection, such as a wired Ethernet connection, or is established wirelessly as discussed below. Likewise, the additional connections with other components of the computer system 900 are physical connections or are established wirelessly. Network 930 alternatively be directly connected to the bus 908.

While the computer-readable medium 922 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 922 is non-transitory, and may be tangible.

The computer-readable medium 922 includes a solid-state memory such as a memory card or other package that houses one or more non-volatile read-only memories. The computer-readable medium 922 is a random-access memory or other volatile re-writable memory. Additionally or alternatively, the computer-readable medium 922 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 900 is connected to network 930. Network 930 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 930 includes wide area networks (WAN), such as the Internet, local area networks (LAN), campus area networks, metropolitan area networks, a direct connection such as through a Universal Serial Bus (USB) port, or any other networks that allows for data communication. Network 930 is configured to couple one computing device to another computing device to enable communication of data between the devices. Network 930 is generally enabled to employ any form of machine-readable media for communicating information from one device to another. Network 930 includes communication methods by which information travels between computing devices. Network 930 is divided into sub-networks. The sub-networks allow access to all of the other components connected thereto or the sub-networks restrict access between the components. Network 930 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention are practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications are made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method comprising: receiving, by one or more processors, one or more documents, wherein the one or more documents include medical records; extracting, by the one or more processors and utilizing an optical character recognition (OCR) engine, text from the one or more documents; determining, by the one or more processors and utilizing a natural language processing (NLP) model, one or more predictions and attention scores for one or more tokens in the one or more documents, wherein each of the one or more tokens represents a word in the extracted text; aggregating, by the one or more processors, the one or more tokens based on the one or more attention scores to construct sentences; and causing to be displayed, by the one or more processors, a presentation of the constructed sentences in a graphical user interface of a device.

Example 2. The computer-implemented method of example 1, further comprising: generating, by the one or more processors utilizing the OCR engine, one or more bounding boxes for recognized words and/or phrases in the one or more documents, wherein the one or more bounding boxes indicate the one or more predictions and attention scores.

Example 3. The computer-implemented method of example 2, wherein the presentation of the constructed sentences comprises: superimposing, by the one or more processors, the one or more bounding boxes over the recognized words and/or phrases in the one or more documents, wherein the one or more bounding boxes are colored and/or semi-transparent.

Example 4. The computer-implemented method of example 3, wherein an intensity of the color or transparency of each of the one or more bounding boxes represents a magnitude of the corresponding attention score.

Example 5. The computer-implemented method of any of the preceding examples, further comprising: determining, by the one or more processors, one or more intervals to cluster the one or more tokens with high attention scores by utilizing an expanding window technique, wherein the one or more tokens with high attention scores are clustered based, at least in part, on a task-based parameter that indicates a quantity of data sought during processing of the one or more documents.

Example 6. The computer-implemented method of example 5, wherein the one or more intervals are positioned around the one or more tokens with high attention scores, and wherein overlapping intervals are merged.

Example 7. The computer-implemented method of example 5, further comprising: determining, by the one or more processors, an unnormalized aggregated attention score for each interval by summing the high attention scores within the interval; and determining, by the one or more processors, a normalized aggregated attention score for each interval based on a softmax function.

Example 8. The computer-implemented method of any of the preceding examples, further comprising: determining, by the one or more processors, labelled data upon processing of the one or more documents to train or update the NLP model.

Example 9. The computer-implemented method of any of the preceding examples, wherein the one or more documents include scanned images of typed and/or handwritten text.

Example 10. The computer-implemented method of example 9, wherein the scanned images are in a portable document format.

Example 11. The computer-implemented method of any of the preceding examples, wherein the NLP model includes at least one of an attention-based model, a rule-based model, or a statistical model.

Example 12. The computer-implemented method of any of the preceding examples, wherein the NLP model utilizes at least one of logistic regression or a neural network.

Example 13. The computer-implemented method of any of the preceding examples, wherein the NLP model performs at least one of text classification, named entity recognition, or entity linking on the one or more documents.

Example 14. The computer-implemented method of any of the preceding examples, further comprising: determining, by the one or more processors, a threshold value for the attention scores; and filtering, by the one or more processors, at least a portion of the one or more tokens based on the threshold value.

Example 15. The computer-implemented method of example 14, wherein the filtered portion of the one or more tokens are utilized based, at least in part, on a context of the constructed sentences.

Example 16. The computer-implemented method of any of the preceding examples, wherein the extracted text includes words and locations of the words within the one or more documents.

Example 17. A system comprising: one or more processors; and at least one non-transitory computer readable medium storing instructions which, when executed by the one or more processors, cause the one or more processors to perform operations comprising: receiving one or more documents, wherein the one or more documents include medical records; extracting, utilizing an optical character recognition (OCR) engine, text from the one or more documents; determining, utilizing a natural language processing (NLP) model, one or more predictions and attention scores for one or more tokens in the one or more documents, wherein each of the one or more tokens represents a word in the extracted text; aggregating the one or more tokens based on the one or more attention scores to construct sentences; and causing to be displayed a presentation of the constructed sentences in a graphical user interface of a device.

Example 18. The system of example 17, further comprising: generating, utilizing the OCR engine, one or more bounding boxes for recognized words and/or phrases in the one or more documents, wherein the one or more bounding boxes indicate the one or more predictions and attention scores; and superimposing the one or more bounding boxes over the recognized words and/or phrases in the one or more documents, wherein the one or more bounding boxes are colored and/or semi-transparent, wherein an intensity of the color or transparency of each of the one or more bounding boxes represents a magnitude of the corresponding attention score.

Example 19. The system of any of examples 17-18, further comprising: determining one or more intervals to cluster the one or more tokens with high attention scores by utilizing an expanding window technique, wherein the one or more tokens with high attention scores are clustered based, at least in part, on a task-based parameter that indicates a quantity of data sought during processing of the one or more documents, wherein the one or more intervals are positioned around the one or more tokens with high attention scores, and wherein overlapping intervals are merged.

Example 20. A non-transitory computer readable medium storing instructions which, when executed by one or more processors, cause the one or more processors to perform operations comprising: receiving one or more documents, wherein the one or more documents include medical records; extracting, utilizing an optical character recognition (OCR) engine, text from the one or more documents; determining, utilizing a natural language processing (NLP) model, one or more predictions and attention scores for one or more tokens in the one or more documents, wherein each of the one or more tokens represents a word in the extracted text; aggregating the one or more tokens based on the one or more attention scores to construct sentences; and causing to be displayed a presentation of the constructed sentences in a graphical user interface of a device.

What is claimed is:

1. A computer-implemented method comprising:
receiving, by one or more processors, one or more documents, wherein the one or more documents include medical records;
extracting, by the one or more processors and utilizing an optical character recognition (OCR) engine, text from the one or more documents;
determining, by the one or more processors and utilizing a natural language processing (NLP) model, one or more predictions and attention scores for one or more tokens in the one or more documents, wherein each of the one or more tokens represents a word in the extracted text;
aggregating, by the one or more processors, the one or more tokens based on the one or more attention scores to construct sentences; and
causing to be displayed, by the one or more processors, a presentation of the constructed sentences in a graphical user interface of a device.

2. The computer-implemented method of claim 1, further comprising:
generating, by the one or more processors utilizing the OCR engine, one or more bounding boxes for recognized words and/or phrases in the one or more documents, wherein the one or more bounding boxes indicate the one or more predictions and attention scores.

3. The computer-implemented method of claim 2, wherein the presentation of the constructed sentences comprises:
superimposing, by the one or more processors, the one or more bounding boxes over the recognized words and/or phrases in the one or more documents, wherein the one or more bounding boxes are colored and/or semi-transparent.

4. The computer-implemented method of claim 3, wherein an intensity of the color or transparency of each of the one or more bounding boxes represents a magnitude of the corresponding attention score.

5. The computer-implemented method of claim 1, further comprising:
determining, by the one or more processors, one or more intervals to cluster the one or more tokens with high attention scores by utilizing an expanding window technique, wherein the one or more tokens with high attention scores are clustered based, at least in part, on a task-based parameter that indicates a quantity of data sought during processing of the one or more documents.

6. The computer-implemented method of claim 5, wherein the one or more intervals are positioned around the one or more tokens with high attention scores, and wherein overlapping intervals are merged.

7. The computer-implemented method of claim 5, further comprising:
determining, by the one or more processors, an unnormalized aggregated attention score for each interval by summing the high attention scores within the interval; and
determining, by the one or more processors, a normalized aggregated attention score for each interval based on a softmax function.

8. The computer-implemented method of claim 1, further comprising:
determining, by the one or more processors, labelled data upon processing of the one or more documents to train or update the NLP model.

9. The computer-implemented method of claim 1, wherein the one or more documents include scanned images of typed and/or handwritten text.

10. The computer-implemented method of claim 9, wherein the scanned images are in a portable document format.

11. The computer-implemented method of claim 1, wherein the NLP model includes at least one of an attention-based model, a rule-based model, or a statistical model.

12. The computer-implemented method of claim 1, wherein the NLP model utilizes at least one of logistic regression or a neural network.

13. The computer-implemented method of claim 1, wherein the NLP model performs at least one of text classification, named entity recognition, or entity linking on the one or more documents.

14. The computer-implemented method of claim 1, further comprising:
determining, by the one or more processors, a threshold value for the attention scores; and
filtering, by the one or more processors, at least a portion of the one or more tokens based on the threshold value.

15. The computer-implemented method of claim 14, wherein the filtered portion of the one or more tokens are utilized based, at least in part, on a context of the constructed sentences.

16. The computer-implemented method of claim 1, wherein the extracted text includes words and locations of the words within the one or more documents.

17. A system comprising:
one or more processors; and
at least one non-transitory computer readable medium storing instructions which, when executed by the one or more processors, cause the one or more processors to perform operations comprising:
receiving one or more documents, wherein the one or more documents include medical records;
extracting, utilizing an optical character recognition (OCR) engine, text from the one or more documents;
determining, utilizing a natural language processing (NLP) model, one or more predictions and attention scores for one or more tokens in the one or more documents, wherein each of the one or more tokens represents a word in the extracted text;
aggregating the one or more tokens based on the one or more attention scores to construct sentences; and
causing to be displayed a presentation of the constructed sentences in a graphical user interface of a device.

18. The system of claim 17, further comprising:
generating, utilizing the OCR engine, one or more bounding boxes for recognized words and/or phrases in the one or more documents, wherein the one or more bounding boxes indicate the one or more predictions and attention scores; and
superimposing the one or more bounding boxes over the recognized words and/or phrases in the one or more documents, wherein the one or more bounding boxes are colored and/or semi-transparent, wherein an intensity of the color or transparency of each of the one or more bounding boxes represents a magnitude of the corresponding attention score.

19. The system of claim 17, further comprising:
determining one or more intervals to cluster the one or more tokens with high attention scores by utilizing an expanding window technique, wherein the one or more tokens with high attention scores are clustered based, at least in part, on a task-based parameter that indicates a quantity of data sought during processing of the one or more documents,
wherein the one or more intervals are positioned around the one or more tokens with high attention scores, and wherein overlapping intervals are merged.

20. A non-transitory computer readable medium storing instructions which, when executed by one or more processors, cause the one or more processors to perform operations comprising:
receiving one or more documents, wherein the one or more documents include medical records;
extracting, utilizing an optical character recognition (OCR) engine, text from the one or more documents;
determining, utilizing a natural language processing (NLP) model, one or more predictions and attention scores for one or more tokens in the one or more documents, wherein each of the one or more tokens represents a word in the extracted text;
aggregating the one or more tokens based on the one or more attention scores to construct sentences; and
causing to be displayed a presentation of the constructed sentences in a graphical user interface of a device.
